(19) United States
(12) Patent Application Publication
(10) Pub. No.: US 2023/0035256 A1
(43) Pub. Date: Feb. 2, 2023

(54) AUTOMOBILE TIRE PRESSURE DISPLAY

(71) Applicant: I YUAN PRECISION INDUSTRIAL CO., LTD., Taoyuan City (TW)

(72) Inventor: Chieh Shih WU, Taoyuan City (TW)

(21) Appl. No.: 17/388,021

(22) Filed: Jul. 29, 2021

(51) Int. Cl. B60C 23/04; B60K 35/00; B60Q 5/00

(52) U.S. Cl. CPC B60C 23/0479; B60K 35/00; B60Q 5/005; B60C 23/0403; B60C 23/0486; B60K 2370/152; B60K 2370/16; B60K 2370/48; B60K 2370/157

(57) ABSTRACT

The present invention relates generally to an automobile tire pressure display, which has a host matching the tire pressure detectors of any brands to achieve monitoring effect, comprising a MCU, a low frequency transmitting unit, a radio frequency receiving/transmitting unit and a database unit; in implementation, the MCU sends different low frequency commands to wake up the tire pressure detector, and receives the radio frequency signal from the tire pressure detector, which is matched with the vehicle type protocols in the database unit, if the judgment succeeds, the MCU records the vehicle type protocol and monitors the pressure and temperature values of tire pressure detector; on the contrary, if the judgment fails, the commands are sent and the signals are received continuously to judge whether the vehicle type protocol is correct or not, till success and it is recorded in the database unit.

### BACKGROUND OF INVENTION

### 1. Field of the Invention

The present invention relates generally to a tire pressure detection technology, and more particularly to an innovative automobile tire pressure display which allows the user to select applicable vehicles at any time as required, and it is still workable when the vehicle is changed.

### 2. Description of Related Art

Since 2007, the U.S. has classified the tire pressure detector as a standard equipment of commercially available vehicles. However, most vehicles only have a tire pressure caution light, when the caution light is on, the user must stop the vehicle and check the tires one by one, so as to know why the caution light is triggered. The single light signal cannot convey the real-time condition of tires exactly.

The tire pressure display is a product for solving the above problem, the tire condition can be observed instantly through this product, including underpressure of any tire, fast or slow pressure relief induced by the tire pierced with a nail in motion, overtemperature of tire and so on. Therefore, this product can enhance the driving safety and convenience.

However, the tire pressure displays on the present market have the following deficiencies to be improved, including 1, the commercially available tire pressure displays are set as a single specified model and vehicle when leaving factory, they cannot be installed on other vehicles freely; 2, a part of commercially available tire pressure displays must be used with special tire pressure detectors; 3, the tire pressure detector shall be triggered by tire pressure relief to send signals, the tire shall be depressurized and inflated, the process is complicated and inconvenient, and a deflation/inflation tool is required; 4, the device shall be installed by automobile refitting personnel; 5, the commercially available tire pressure displays cannot update software automatically.

To sum up, the implementation and application of the present tire pressure display are complicated and inconvenient, especially when the vehicle is changed, the commercially available tire pressure display cannot work on the new vehicle. Therefore, the inventor of this project created this more practical and perfect automobile tire pressure display through continuous research and test based on years' experience in design, hoping to benefit the common people.

### SUMMARY OF THE INVENTION

The first objective of the present invention is to provide a brand new automobile tire pressure display, which is applicable to most vehicles with a standard tire pressure detector on the market.

The second objective of the present invention is to provide an automobile tire pressure display, so that the applicable vehicle can be selected freely at any time according to the user requirement, and it is still workable when the vehicle is changed.

The third objective of the present invention is to provide an automobile tire pressure display, so that at most four groups of vehicle data can be memorized at the same time, it can be used in different vehicles by the user who has several vehicles.

To attain the above objectives, the present invention discloses an automobile tire pressure display, which has a host matching the tire pressure detectors of any brands to achieve monitoring effect, comprising a MCU with multiple function options, including a vehicle selection mode, for freely selecting the matched vehicle brand; a judgment mode, for judging whether the received radio frequency signal conforms to the built-in vehicle type protocol or not; a low frequency trigger mode, for sending low frequency commands; and a radio frequency receiving mode, for receiving the radio frequency signals from the outside; a low frequency transmitting unit, sending low frequency commands in low frequency trigger mode to try to wake up the tire pressure detector; a radio frequency receiving/transmitting unit, which receives the radio frequency signals from the external tire pressure detector and transmits them to the MCU; a database unit, storing the TPMS data of different years, vehicle series and vehicle types and at least more than one group of user's automobile data. In the implementation, different low frequency commands are sent by more than one low frequency trigger mode to continuously judge the vehicle type protocol, when the judgment succeeds, the MCU records and monitors the pressure and temperature values of tire pressure detector.

In an embodiment, the host includes a USB input port for updating the data in the database unit at any time.

The matching method of the automobile tire pressure display includes the following steps: a, vehicle selection mode: the vehicle selection mode is chosen in function select, the TPMS data of corresponding vehicle series and vehicle type in the built-in database unit are selected according to the user's vehicle brand; b, low frequency trigger mode: a low frequency command is sent to try to wake up the original manufacturer's tire pressure detector; c, tire pressure detector: when the waken original manufacturer's tire pressure detector receives the command in low frequency trigger mode, a radio frequency signal is sent if the condition is matched; d, radio frequency receiving mode: the radio frequency signal from the tire pressure detector is received and sent to the MCU for processing; e, MCU judgment mode: when the MCU judgment succeeds, the vehicle type protocol is recorded in the database unit; f, monitoring mode: when the setting succeeds, the display unit displays the pressure and temperature values of the monitored tire pressure detector.

### BRIEF DESCRIPTION OF THE DRAWINGS

FIG. 1 is the block diagram of the automobile tire pressure display of the present invention.

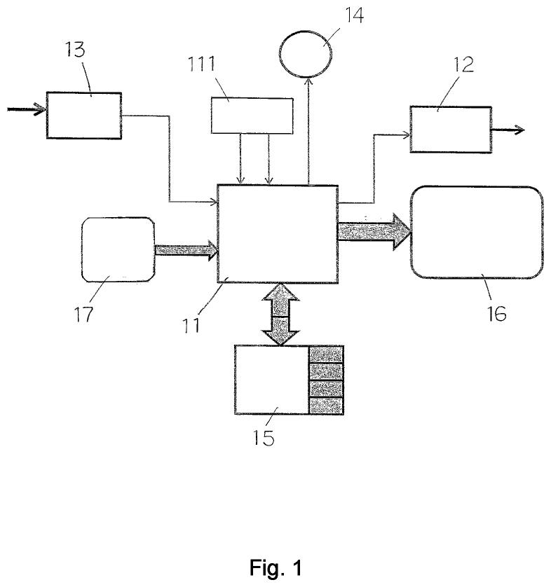

FIG. 2 is the flow chart of the automobile tire pressure display of the present invention.

### DETAILED DESCRIPTION OF THE INVENTION

The present invention provides an automobile tire pressure display, which is applicable to any selected vehicle at any time. The automobile tire pressure display has a host (1) which matches the tire pressure detectors of any brands to achieve monitoring effect, comprising a MCU (11) with multiple function options, including a vehicle selection mode, for selecting the matched vehicle brand freely; a judgment mode, for judging whether the received radio frequency signal conforms to the built-in vehicle type protocol or not; a low frequency trigger mode, for sending low frequency commands; and a radio frequency receiving mode, for receiving the radio frequency signals from the outside; a low frequency transmitting unit (12), electrically connected to the MCU (11), for sending low frequency commands in low frequency trigger mode to try to wake up the external tire pressure detector (2); a radio frequency receiving/transmitting unit (13), electrically connected to the MCU (11), for receiving the radio frequency signals from the external tire pressure detectors in radio frequency receiving mode and sending them to the MCU (12) for processing; a buzzer unit (14), electrically connected to the MCU (11), providing state caution sound, so that the owner can know the state of at least one tire instantly; a database unit (15), electrically connected to the MCU (12), storing the TPMS data of different years, vehicle series and vehicle types and at least more than one group of user's automobile TPMS; and a display unit (16), electrically connected to the MCU (12), displaying the number matching the external tire pressure detector, real-time pressure and temperature values measured by the tire pressure detector.

The host (1) of automobile tire pressure display of the present invention has a USB input port (17), the data in the database unit (15) can be updated at any time, so as to make sure the host (1) contains complete TPMS data of different years, vehicle series and vehicle types, which are convenient for the matching operation of the host.

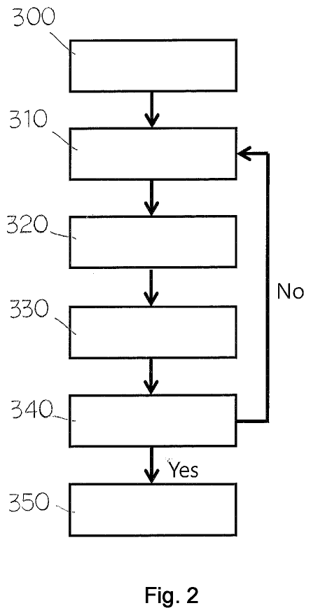

As shown in FIG. 2, in the implementation of the said host (1), the operation procedure of the automobile tire pressure display includes: first of all, the vehicle selection mode is selected in function select, the TPMS data of the corresponding vehicle series and vehicle type in the built-in database unit (15) are selected according to the user's vehicle brand; secondly, the low frequency trigger mode sends a low frequency command to try to wake up the original manufacturer's tire pressure detector; afterwards, when the waken original manufacturer's tire pressure detector receives the command in low frequency trigger mode, the radio frequency signal is sent if the condition is matched; at this point, the radio frequency signal from the tire pressure detector is received in radio frequency receiving mode and sent to the MCU (12) for processing; finally, when the MCU (12) judgment succeeds, the vehicle type protocol is recorded in the database unit (15), and the display unit (16) displays the pressure and temperature values of the monitored tire pressure detector. On the contrary, if the judgment fails, different low frequency commands are sent to continuously judge whether the vehicle type protocol is correct or not, till success and it is recorded in the database unit (15); thus the host (1) is matched and connected to the tire pressure detector on current vehicle, so as to detect the tire pressure instantly.

According to the above description, the commercially available tire pressure display products are only applicable to the preset single specified model and vehicle when leaving factory, and they cannot be freely installed on other vehicles, whereas the present invention has the following characteristics: 1, it is applicable to most vehicles with a standard tire pressure detector on the market after leaving factory. 2, the applicable vehicle can be selected freely at any time as required, and it is still workable when the vehicle is changed. 3, at most four groups of vehicle data can be memorized at the same time, it can be used in different vehicles by the user who has several vehicles.

Moreover, the commercially available tire pressure display products require a complicated pressure relief process to trigger the data feedback of tire pressure detector, whereas the present invention only uses the display to send trigger signals to the tires, the tire pressure detector feeds back data when it is triggered, the learning is completed when the data are received, the process is simple, fast and convenient. Additionally, the present invention is used together with the original manufacturer's tire pressure detector, it can be installed by the user in most cases, whereas the commercially available products require automobile refitting personnel to install the specific matched tire pressure detector, the present invention is convenient, and the application threshold is reduced greatly.

Although the invention has been explained in relation to its preferred embodiment, it is to be understood that many other possible modifications and variations can be made without departing from the spirit and scope of the invention as hereinafter claimed.

1. An automobile tire pressure display, which has a host that matches the tire pressure detectors of any brands to achieve monitoring effect, comprising:
a MCU, with multiple function options, at least including a vehicle selection mode, for selecting the matched vehicle brand freely; a judgment mode, for judging whether the received radio frequency signal conforms to the built-in vehicle type protocol or not; a low frequency trigger mode, for sending low frequency commands; and a radio frequency receiving mode, for receiving the radio frequency signals from the outside;
a low frequency transmitting unit, electrically connected to the MCU, for sending low frequency commands in low frequency trigger mode to try to wake up the external tire pressure detector;
a radio frequency receiving/transmitting unit, electrically connected to the MCU, for receiving the radio frequency signals from the external tire pressure detector in radio frequency receiving mode and transmitting it to the MCU for processing;
a buzzer unit, electrically connected to the MCU, providing state caution sound, so that the owner can know the state of at least one tire instantly;
a database unit, electrically connected to the MCU, storing the TPMS data of all vehicle series and vehicle types of different years, and at least more than one group of the user's TPMS data; and
a display unit, electrically connected to the MCU, displaying the number matching the tire pressure detector and the real-time pressure and temperature values measured by the tire pressure detector.

2. The automobile tire pressure display defined in claim 1, wherein the host has a USB input port for updating the database.

3. A matching method of automobile tire pressure display, including the following steps:
vehicle selection mode: the vehicle selection mode is selected in function select, the TPMS data of the corresponding vehicle series and vehicle type in the built-in database unit are selected according to the user's vehicle brand;
low frequency trigger mode: sending different low frequency commands to try to wake up the original manufacturer's tire pressure detector;
tire pressure detector: when the waken original manufacturer's tire pressure detector receives the command in low frequency trigger mode, the radio frequency signal is sent out if the condition is matched;
radio frequency receiving mode: the radio frequency signal from the tire pressure detector is received and transmitted to the MCU for processing;
MCU judgment mode: when the radio frequency signal is processed by the MCU, the correct vehicle type protocol of this tire pressure detector is obtained, and the vehicle type protocol is recorded in the database unit;
monitoring mode: the display unit displays the pressure and temperature values of the monitored tire pressure detector.

4. The matching method of automobile tire pressure display defined in claim 3, wherein in the MCU judgment mode, in the case of failure (i.e. unmatch), the low frequency trigger mode, radio frequency receiving mode and MCU judgment mode are repeated till the matching succeeds, and it is recorded in the database unit.
